(19) United States
(12) Patent Application Publication
(10) Pub. No.: US 2011/0185969 A1
(43) Pub. Date: Aug. 4, 2011

(54) DUAL HEATING FOR PRECISE WAFER TEMPERATURE CONTROL

(75) Inventor: Michael X. Yang, Palo Alto, CA (US)

(73) Assignee: VARIAN SEMICONDUCTOR EQUIPMENT ASSOCIATES, INC., Gloucester, MA (US)

(21) Appl. No.: 12/853,394

(22) Filed: Aug. 10, 2010

Related U.S. Application Data
(60) Provisional application No. 61/235,790, filed on Aug. 21, 2009.

(51) Int. Cl. B05C 11/00

(52) U.S. Cl. 118/666

(57) ABSTRACT

An improved method of heating a workpiece positioned on a susceptor is disclosed. The method using both primary heating, such as by resistive or inductive heating elements, and localized secondary heating, such as by heating lamps. The primary heating system is used to globally regulate the temperature of the susceptor. The heating lamps are used to provide localized heating to particular regions of the workpieces, based on measured temperatures. A wafer temperature mapping unit is used to measure the temperature of the top surface of the workpieces, so that an appropriate amount of heat can be applied to each localized region. In some embodiments, the susceptor rotates, thereby allowing fewer localized heating elements and temperature sensors to be employed.

This application claims priority of U.S. Provisional Patent Application Ser. No. 61/235,790 filed Aug. 21, 2009, the disclosure of which is incorporated herein by reference.

### FIELD

This invention relates to temperature control and, more particularly, to temperature control in a deposition process.

### BACKGROUND

Chemical vapor deposition (CVD) is a film deposition method based on chemical reactions of precursor materials. Often the formation of the deposited layer occurs by pyrolysis of the chemicals at the substrate surface. In some other cases, dissociation of the chemicals is initiated in gas phase adjacent to the high temperature substrate surface.

High temperature thermal chemical vapor deposition is important for material fabrication in the semiconductor, optoelectronic, or other industries. For instance, silicon, silicon oxide, and silicon nitride films may be deposited from silicon precursors such as SiH₄, SiH₂Cl₂, SiHCl₃, SiHCl₄, or Si₂H₆ at temperatures between approximately 500° C. and 1000° C. III-V compounds such as InP, GaAs, GaN, InN, AlN, and their tertiary analogues may be fabricated from metalorganic precursors such as In(CH₃)₃, Ga(CH₃)₃, or Al(CH₃)₃ at a temperature between approximately 500° C. and 1200° C. III-V compounds such as GaN may be also fabricated from metal hydride precursors such as GaCl₃. Comparing with film deposition from metalorganic precursors, film deposition from metal hydride precursors may take place at a lower temperature or at a higher rate.

In a thermal deposition process, the composition and/or deposition rate of the deposited layer may be related to temperature. Temperature variations across a substrate surface may lead to uneven film composition and/or uneven film thickness across the substrate surface. Accordingly, there is a need in the art for an improved method and apparatus to provide temperature uniformity in a chemical vapor deposition (CVD) apparatus.

### SUMMARY

An improved method of heating a workpiece positioned on a susceptor is disclosed. The method uses both primary heating, such as by resistive or inductive heating elements, and localized secondary heating, such as by heating lamps. The primary heating system is used to globally regulate the temperature of the susceptor. The heating lamps are used to provide localized heating to particular regions of the workpieces, based on measured temperatures. A wafer temperature mapping unit is used to measure the temperature of the top surface of the workpieces, so that an appropriate amount of heat can be applied to each localized region. In some embodiments, the susceptor rotates, thereby allowing fewer localized heating elements and temperature sensors to be employed.

### BRIEF DESCRIPTION OF THE DRAWINGS

For a better understanding of the present disclosure, reference is made to the accompanying drawings, which are incorporated herein by reference and in which:

FIG. 1 is a cross-sectional view of a system incorporating resistive/inductive heating.

FIGS. 2a-b are views of resistive/inductive heating elements.

FIG. 3 is a cross-sectional view of a system incorporating radiant heating.

FIG. 4 is a cross-sectional view of a system incorporating embodiments disclosed herein.

FIGS. 5a-b are top view of systems incorporating embodiments disclosed herein.

### DETAILED DESCRIPTION

The apparatus is described herein in connection with a CVD reactor. For example, the apparatus may be used in high temperature applications involving chemical vapor deposition (CVD) or epitaxial deposition. However, the apparatus can be used with other systems and processes involved in semiconductor, optoelectronics, or other industries. Thus, the invention is not limited to the specific embodiments described below.

Equipment for thermal deposition is generally divided into two categories: hot wall reactors and cold wall reactors. Hot wall reactors include furnaces where the temperature is uniform inside the reactor. Cold wall reactors include equipment where only the workpiece is heated to the process temperature. It is more difficult to control temperature uniformity in a cold wall reactor than a hot wall reactor. Cold wall reactors, however, avoid chamber wall coating to prevent temperature drift, minimize precursor decompositions, and avoid deposition at the backside of the workpieces.

There are several heating methods for a cold wall reactor including resistive heating, inductive heating, and radiant heating.

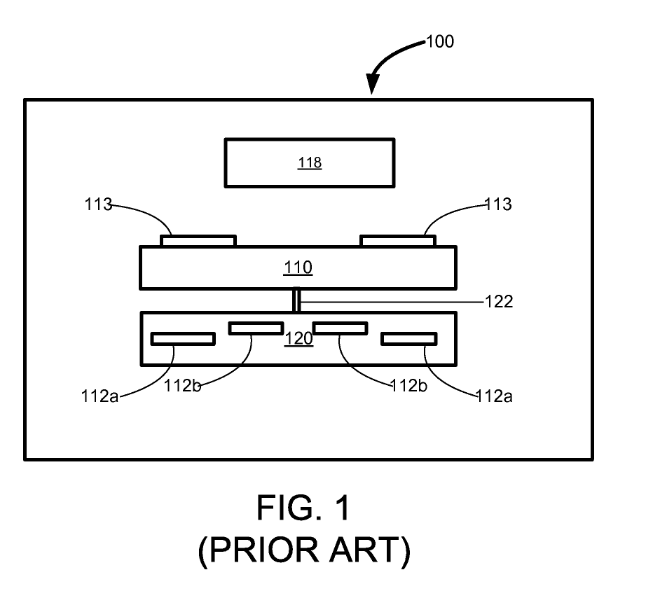

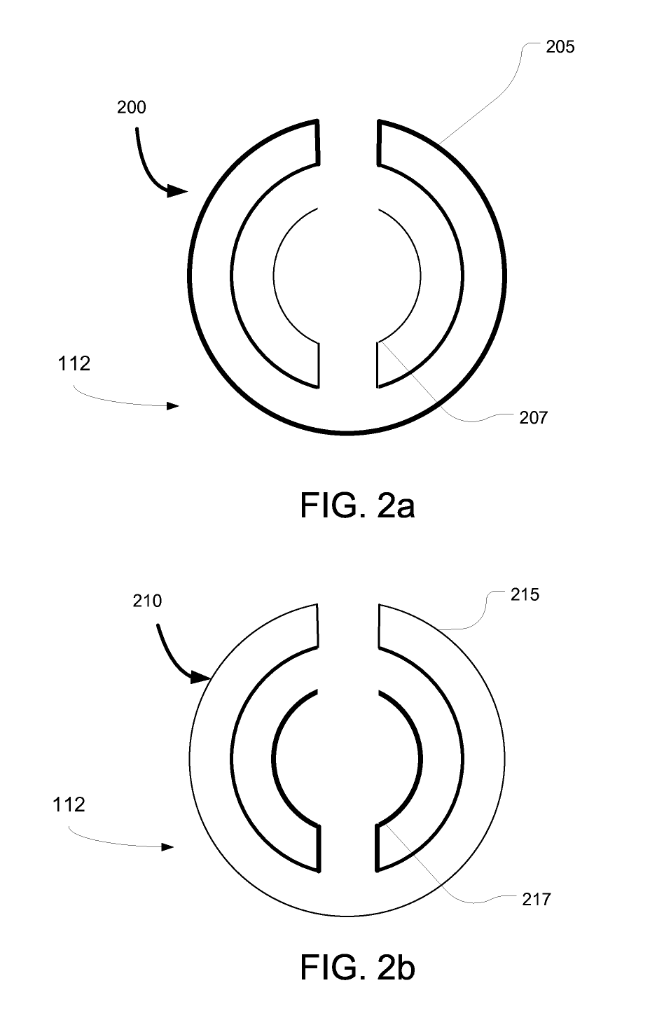

FIG. 1 shows a chamber 100 used for resistive or inductive heating. In this embodiment, one or more workpieces 113 are placed on a susceptor 110. The susceptor 110 may be located atop a stage 120. The susceptor 110 may rotate relative to the stage 120, such as by use of shaft 122. The susceptor 110 is typically heated from below by resistive or inductive heating elements 112. The resistive or inductive heating elements may be located within stage 120. These heating elements 112 may be laid out in a circular or radial pattern. FIG. 2 shows one such pattern 200, although other patterns are within the scope of the disclosure. To ensure heating uniformity, radial control of the susceptor temperature may be achieved by varying the width of various portions of the resistive heating elements, based on their radial position. FIG. 2 shows that the outermost portions 205 of the heating element 112 may be thicker than the inner portions 207. In some embodiments, radial control of the susceptor temperature is achieved by varying the distance between individual resistive/inductive elements 112 and the susceptor 110. For example, FIG. 1 shows heating elements 112a located further from the susceptor 110 than heating elements 112b. In other embodiments, the radially outer heating elements 112a may be closer to the susceptor 110 than the radially inner heating elements 112b. In other embodiments, a multi-zone heating system also may be used where multiple heating coils with different layouts and/or geometries are superimposed on top of each other and power distributions between the different heating elements are adjusted. FIG. 2b shows a heating element 112, having a pattern 210, similar to that in FIG. 2a. However, while the heating element 112 has a pattern 210 having a similar shape, the widths of the various portions are different. In this embodiment, the outer portions 215 are thinner than the inner portions 217. These two heating patterns 200, 210 may be superimposed on each other and located within the stage 120. In some embodiments, one of the patterns may be rotated relative to the second pattern. After optimization of the multi-zone heating, susceptor temperature angular distribution may be adjusted. As described above, the susceptor 110 may rotate about shaft 120. Rotation of the susceptor 110 relative to the heating elements 112 or planetary motion of the workpieces 113 on the susceptor 110 also may improve temperature uniformity and help achieve temperature uniformity angular distribution. Planetary motion involves rotating the workpieces 113 in either the same direction as the susceptor 110 or the opposite direction of the susceptor 110 while the susceptor 110 rotates.

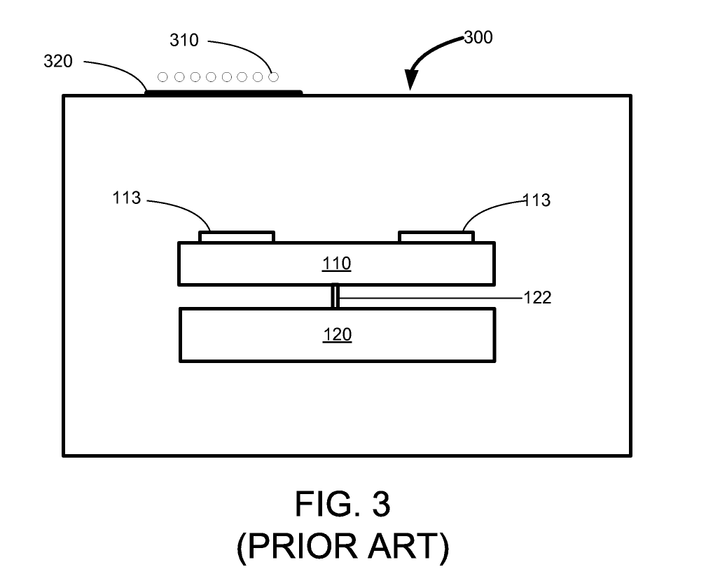

The second common method used to heat a workpiece is radiant heating. FIG. 3 shows a chamber 300 used for radiant heating. As in FIG. 1, the chamber includes a susceptor 110, holding one or more workpieces 113. The susceptor 110 may be rotatably attached to a stage 120, via shaft 122. In this embodiment, the workpieces 113 are heated from above the susceptor 110, such as by heating lamps 310. The term “heating lamps” refers to conventional heating lamps, as well as lasers, laser diodes and other suitable means. These heat lamps may be located outside of chamber 300, so as not to be affected by the environment within the chamber 300. A transparent or translucent window 320 is located within a wall of top surface of the chamber 300. The heating lamps 310 are placed near the window 320 so as to shine down toward the workpieces 113. The heating effect of the individual components of the heating lamps 310 is localized, in that each typically only heats a small portion of the susceptor 110 or workpiece 113. In many applications, multiple heat lamps are laid out to cover the entire top surface of the susceptor. If the susceptor 110 is able to rotate, the heating lamps 310 can be placed such as to heat only a small portion of the susceptor 110. Rotation of the susceptor 110 brings different portions of the workpieces 113 into the area heated by the lamps 310.

Each of these methods has known shortcomings. For example, resistive/inductive heating only is used to heat the bottom side of the susceptor 110. With heating only from the back side of the susceptor 110, the workpiece 113 temperature is susceptible to the thermal environment within the cold wall reactor. For example, any hardware on the front side (deposition side) of the workpieces 113 may cause heat or radiation reflection. As the deposition temperature increases, such as above 700° C., heat loss through radiation increases. A cold wall reactor may include a gas delivery plate or showerhead design 118 (see FIG. 1) to enable uniform gas distribution. This gas delivery plate 118 may be placed in close proximity with the workpieces 113 to improve gas flow uniformity. Even in a cold wall reactor with laminar gas flow with a side injection design, the distance between the top of the chamber 100 and the workpieces 113 may require minimization to improve gas flow uniformity and precursor conversion efficiency. Yet, if the gas delivery plate 118 is placed in close proximity to the heated susceptor 110 and workpieces 113, heating and deposition on the gas delivery plate 118 may occur. Any emissivity change of the gas delivery plate 118 will affect workpiece 113 temperature and temperature uniformity. In other words, conditions on the side of the workpiece 113 opposite the susceptor 110 may affect the final temperature of the workpiece 113.

Temperature uniformity of the workpieces 113 also may be affected by compliance of the workpiece 113 to the susceptor 110. Susceptor surface curvature, design/manufacturing control, workpiece curvature, and workpiece curvature change during the deposition process all may contribute to this problem.

In some embodiments, workpiece/susceptor compliance issue may be addressed with a chucking of workpiece 113 on the susceptor 110. Both vacuum and electrostatic chucks have been developed for deposition chambers in semiconductor fabrications.

In a vacuum chucking approach, one or multiple vacuum channels are embedded in the susceptor 110, with openings on the upper surface of the susceptor 110. With a relatively high process pressure (>a few torr) in the CVD process, workpieces 113 will adhere to the susceptor 110 due to the pressure delta created between the upper and lower surfaces of the workpiece 113. A vacuum chuck is preferably designed to avoid local cold spots on the workpieces 113 at the openings of the vacuum channels.

In an electrostatic chuck approach, the workpiece 113 is held on the susceptor 110 with an electrostatic force. An electrostatic chuck is preferably designed to avoid conducting or semiconducting materials at the backside and bevel of the workpiece 113.

Even with the implementation of a wafer chucking option, workpiece temperature may still be susceptible to changes in chamber ambient as illustrated above.

It should be noted that heating of the workpieces from the bottom side of the susceptor can also be conducted with heating lamps instead of resistive or inductive heating elements. However, the same issues exist with non-perfect compliance of the workpiece 113 to the susceptor 110. The workpiece-susceptor compliance issue often occurs over a localized area. Heating lamps have local temperature adjustment capabilities. However, in a configuration of heating provided only from bottom of the susceptor 110, a high lateral thermal conductivity of the susceptor, which is desirable for a uniform susceptor temperature, makes local control and adjustment of the workpiece temperature difficult.

Due to such factors, the workpiece 113 temperature uniformity may be worse than the susceptor 110 temperature uniformity with heating of the workpieces only from the bottom side the susceptor. Thus, an uniform susceptor temperature does not guarantee an uniform workpiece temperature. This may vary wafer-to-wafer or run-to-run.

On the other hand, there are issues associated with direct heating from the front side of the workpieces, often using heat lamps. Direct lamp heating to the front side of the wafers or workpieces may enable real-time workpiece temperature uniformity control. Like a rapid thermal processing (RTP) device, lamps may heat workpieces through a window. Local wafer temperature control may be achieved by a mosaic lamp layout and transient control of each lamp. Yet by only heating the front of the workpiece, deposition on the window and subsequent process drift may occur. Run-to-run consistency may be problematic for thick film deposition with lamp heating. Lamp lifetime also may be a concern, and power efficiency for lamp heating is often very poor (<10%).

Thus, both preferred methods of heating workpieces are beset by shortcomings that degrade their effectiveness, especially at high temperatures.

However, each method offers some benefits. The resistive/inductive heating elements are able to provide a relatively constant susceptor temperature, which is a factor in setting workpiece temperature. In addition, the size and composition of the susceptor imply that the temperature changes are gradual over time. Thus, once the susceptor is at the desired temperature, it tends to remain at or near that temperature, due to the heat capacity of the susceptor. This form of heating tends to also produce relatively constant temperatures across the susceptor. Thus, resistive/inductive heating is global in terms of the regions affected, and low frequency in terms of the time constants to alter the temperature of the susceptor.

In contrast, the heating lamps are more localized in their effect. In some embodiments, a heating lamp may heat an area having only a 1-2 mm diameter. In addition, the effect of heating via radiant heating is short-lived. Since the heat is provided by radiant energy, the temperature may quickly change when the source of heat is removed. Finally, the radiant heating may modify the temperature of the workpiece via the top surface, as compared with resistive/inductive heating which heats the bottom surface of the workpiece via the susceptor. In other words, radiant heat from the front side of the workpieces is localized in terms of the regions affected, and high frequency in terms of the time constants to alter the temperature of the workpiece. Thus, these two heating methods have complementary characteristics, which can be employed simultaneously to better control the temperature of a workpiece.

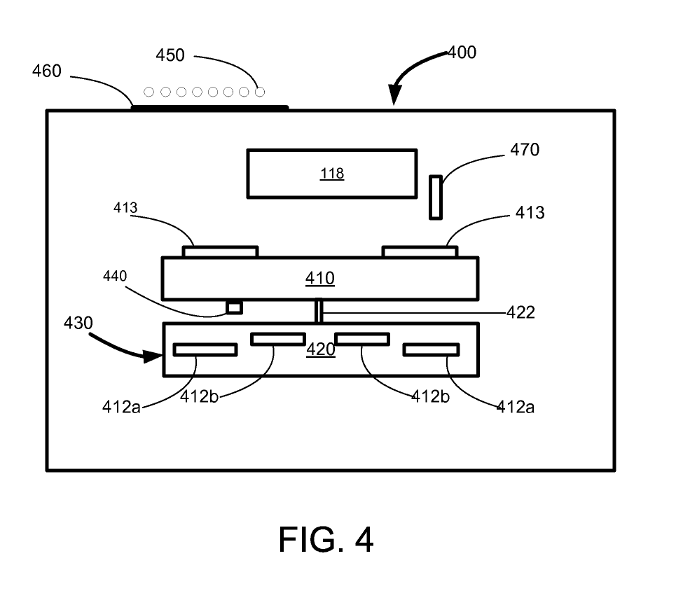

FIG. 4 is a cross-sectional view of a system incorporating both heating methods disclosed herein. This system 400 may enable control of workpiece 413 temperature uniformity and may overcome variations in the reactor thermal ambient, such as those from the emissivity change of the showerhead 418 in the vicinity of the workpiece 413 frontside. Wafer-to-wafer curvature variation and wafer curvature change during film deposition also may be compensated for.

Primary heating 430 is provided through resistive or inductive heaters 412 placed under the susceptor 410 in a stage 420, such as in a circular pattern using the shaft 422. As described earlier, other patterns are possible. These heating elements serve to cause the susceptor to reach and maintain a desired temperature. In some embodiments, one or more temperature sensors 440, such as thermocouples, may be located on the susceptor 410 or stage 420 to allow closed loop control of the heating elements 412. More than one temperature sensor 440 may be used, and their location is not limited by this disclosure. In this embodiment, a controller (not shown) may receive inputs from the temperature sensors 440, and based on these inputs, modify the current or voltage applied to the resistive/inductive heating elements. By iteratively performing these steps, the susceptor 410 may be maintained at a constant temperature.

In addition, one or more heating lamps 450 provide secondary heating. The heating lamps are preferably mounted outside chamber 400, such as near a translucent window 460, such as one made of quartz. In addition, a wafer temperature mapping unit 470 may be employed to measure the temperature at the top surface of the workpiece 413. The wafer temperature mapping unit 470 may use, for example, a pyrometer, an array of pyrometers, or other temperature sensors. Real-time temperature mapping that takes into consideration wafer emissivity change during deposition or other factors may be used.

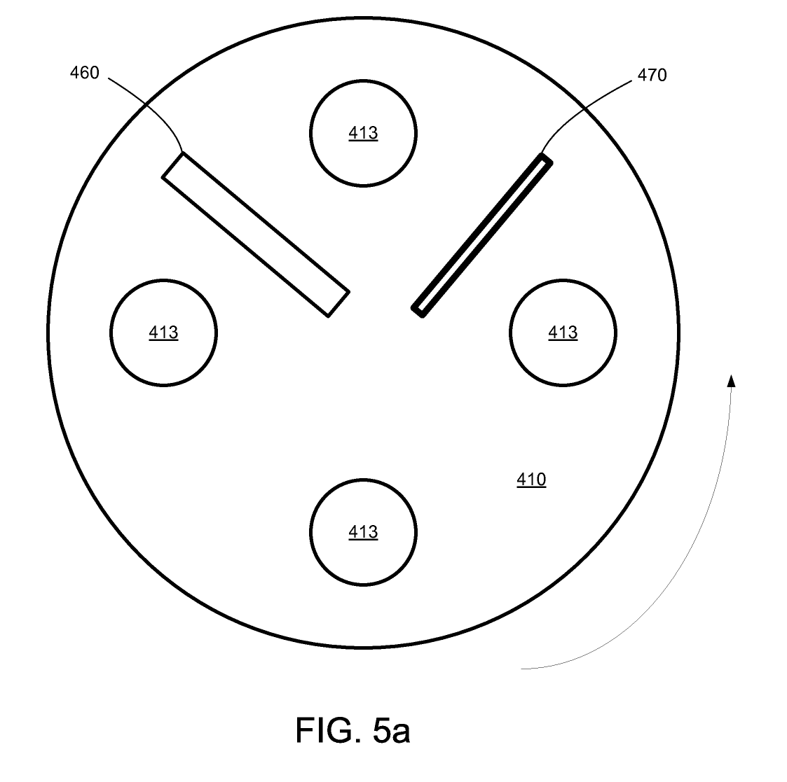

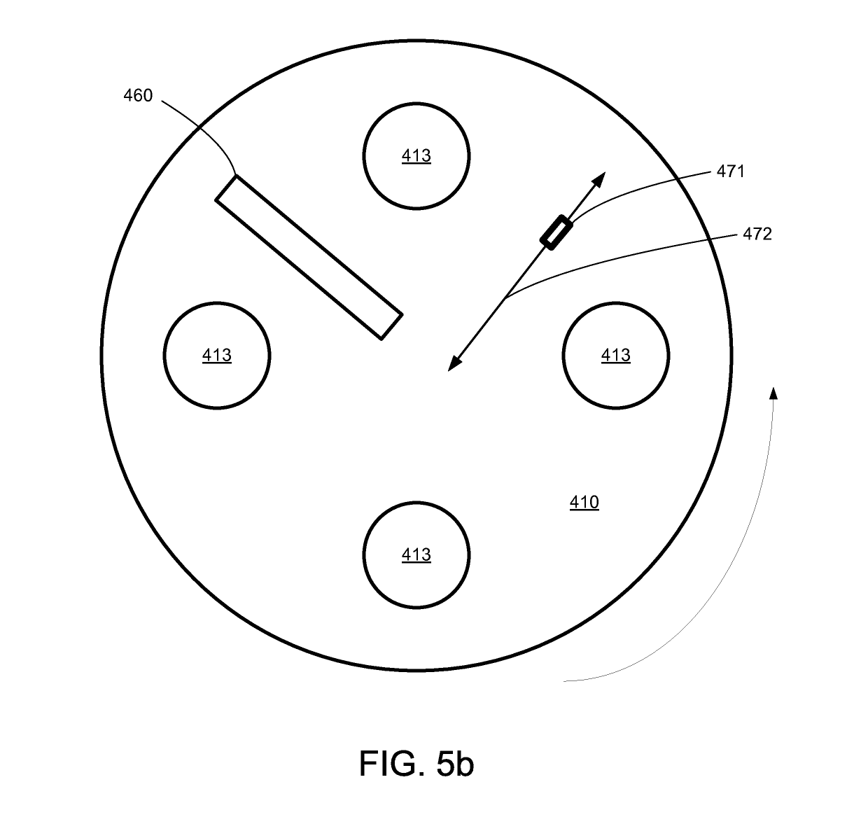

If the susceptor 410 can rotate about the stage 420, the wafer temperature mapping unit 470 need only be capable of measuring temperature radially along susceptor 410. FIGS. 5a-b show top view of the susceptor 410 having a plurality of workpieces 413. Window 460 is located such that heating lamps can radiate energy through the window onto a localized portion of the susceptor 410. The workpieces 413 occupy a portion of the susceptor 410, wherein the innermost portion of the workpiece 413 is closest to the center of the susceptor 410, and the outermost portion of the workpiece 413 is closest to the outer edge of the susceptor 410. The window 460 is preferably configured such that it is of sufficient size and location such that the heating lamps can locally radiate the workpiece 413 from its innermost and outermost portions. In some embodiments, the window 460 may be aligned with a radius of the susceptor 410.

In some embodiments, such as shown in FIG. 5a, an array of pyrometers is used to simultaneously measure the workpiece temperatures along a radius of the susceptor 410. In other embodiments, such as is shown in FIG. 5b, one pyrometer 471 is used, which is capable of movement at least partially in the radial direction, such that by rotation of the susceptor 410 and movement of the pyrometer 471, any point on the surface of the workpiece 413 may be measured. In some embodiments, the pyrometer 471 moves radially, as shown by path 472. In some other embodiments, a small number of pyrometers are used which are capable of movement at least partially in the radial direction. In still other embodiments, the pyrometer or a small number of pyrometers can be stationary but signals can be collected from different radial locations of the workpiece 413 by a set of optics or other methods.

Through the use of a rotating susceptor 410, it is possible to measure each position on the susceptor 410 and to provide radiant heat, as required, to each of these localized positions. In practice, a controller (not shown) receives the inputs from the wafer temperature mapping unit 470. In some cases, such as when moving pyrometers are used, the controller also receives position information associated with the pyrometer so as to determine the portion of the susceptor being measured. Based on the rotation speed of the susceptor, the controller can determine when the measured localized portion of the susceptor 410 will be in the heating region, such as beneath window 460. Based on the measured workpiece temperature data, the controller can then determine the appropriate lamp and intensity should be employed to compensate for temperature variation across the workpiece 413.

With a rotating susceptor 410, the localized heating lamps 450 may have transient power adjustment capability to achieve temperature control at specific localized areas on the workpieces 413. The workpieces 413 may be rotated in and out of the localized heating areas in one instance. As described above, the localized heating lamps 450 may need to operate in a cyclical pattern to match the susceptor 410 rotation speed or frequency. The localized heating lamps 450, in one specific embodiment, operate in a pulse mode synchronized with the susceptor 410 rotation speed while the primary heating elements 412 operate using either single zone or multi-zone heating, independent of the rotation speed of the susceptor 410.

In some embodiments, the temperature uniformity of the susceptor 410 and workpiece 413 is first optimized by the primary heating 430. As described above, primary heating may be resistive or inductive. Furthermore, primary heating may be performed using either open loop or closed loop techniques. In the case of closed loop control, any suitable algorithm, such as P, P-I, or P-I-D, may be employed.

Subsequently, secondary heating, such as from heating lamps 450, may be turned on and off and to different power levels to ensure uniform workpiece temperature uniformity, as described above. Again, the secondary or localized heating may be performed using either open loop or closed loop techniques. In the case of closed loop control, any suitable algorithm, such as P, P-I, or P-I-D, may be employed.

Thus, the primary heating provides low frequency modulation and control, while the localized heating elements provide high frequency temperature modulation.

The materials comprising the heating elements may be optimized for the particular temperatures involved in the process. The resistive heaters may operate at elevated temperatures while the inductive heaters may operate at a high RF frequency.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Furthermore, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A deposition chamber, comprising:
a susceptor having a lower surface and an upper surface, wherein at least one workpiece is positioned on said upper surface;
resistive or inductive heating elements for heating said susceptor to a desired temperature, located proximate said lower surface of said susceptor; and
heating lamps, located above said upper surface for heating said workpiece.

2. The deposition chamber of claim 1, wherein said resistive or inductive heating elements provide low frequency temperature control and said heating lamps provide high frequency temperature control.

3. The deposition chamber of claim 1, wherein said susceptor is rotatably attached to a stage.

4. The deposition chamber of claim 3, wherein said resistive or inductive heating elements provide low frequency temperature control, and said heating lamps provide high frequency temperature control, wherein said heating lamp control frequency is the same as the rotational speed of said susceptor.

5. The deposition chamber of claim 3, wherein said heating lamps are configured to heat a portion of said top surface and said susceptor rotates to allow all portions of said top surface to be heated by said heating lamps.

6. The deposition chamber of claim 1, wherein said heating lamps are lasers.

7. The deposition chamber of claim 1, wherein said heating lamps are laser diodes.

8. The deposition chamber of claim 1, further comprising a vacuum or electrostatic chuck in said susceptor.

9. The deposition chamber of claim 1, further comprising a wafer temperature mapping unit, configured to determine the temperature of a portion of said workpiece.

10. The deposition chamber of claim 9, wherein said susceptor rotates at a predetermined rotational speed, further comprising a controller in communication with said wafer temperature mapping unit and said heating lamps, wherein said controller actuates said heating lamps in response to inputs from said wafer temperature mapping unit and said rotational speed.

11. The deposition chamber of claim 9, wherein said wafer temperature mapping unit comprises movable pyrometers.

12. The deposition chamber of claim 9, wherein said wafer temperature mapping unit comprises a stationary pyrometer with a set of optics to collect information from any radial position on said workpiece.

13. A deposition chamber comprising:
a susceptor configured to hold one or more workpieces;
a first heating element to heat said workpiece at a first rate; and
a second heating element to heat said workpiece at a second rate, different than said first rate.

14. The deposition chamber of claim 13, wherein said first heating element indirectly heats said workpiece by heating said susceptor.

15. The deposition chamber of claim 13, wherein said second heating element directly heats said workpiece.

16. The deposition chamber of claim 13, wherein said second heating element compensates for temperature nonuniformities resulting from said first heating element.
